(19) United States
(12) Patent Application Publication
(10) Pub. No.: US 2008/0160281 A1
(43) Pub. Date: Jul. 3, 2008

(54) Sizing composition for glass fibers

(76) Inventors: Eric L. Vickery, Williamston, SC (US); David M. Boles, Anderson, SC (US); William G. Hager, Westerville, OH (US)

Correspondence Address: OWENS CORNING, 2790 COLUMBUS ROAD, GRANVILLE, OH, 43023, US

(21) Appl. No.: 11/648,237

(22) Filed: Dec. 29, 2006

(51) Int. Cl. B32B 25/02; B32B 17/00; B32B 25/20; C03B 37/16

(52) U.S. Cl. 428/295.1; 156/99; 428/391; 65/480

(57) ABSTRACT

A sizing composition that permits in-line chopping and drying of reinforcement fibers for reinforcing thermoset resins is provided. The size composition includes at least one coupling agent and one or more blocked polyurethane film forming agents. The blocking agent preferably de-blocks at a temperature that permits simultaneous or nearly simultaneous de-blocking and curing of the polyurethane film former. The sized fiber strands may be chopped to form chopped strand segments and dried in a fluidized bed oven, such as a Cratec® drying oven, in-line. The chopped fiber strands may then be used in a bulk molding compound and molded into a reinforced composite article. Chopping the glass fibers in-line lowers the manufacturing costs for products produced from the sized fiber bundles. Further, because the reinforcement fibers can be chopped and dried at a much faster rate with the inventive size composition compared to conventional off-line chopping processes, productivity is increased.

### TECHNICAL FIELD AND INDUSTRIAL APPLICABILITY OF THE INVENTION

The present invention relates generally to a sizing composition for reinforcing fiber materials, and more particularly, to a chemical composition for chopped reinforcement fibers used to reinforce thermoset resins.

### BACKGROUND OF THE INVENTION

Glass fibers are useful in a variety of technologies. For example, glass fibers are commonly used as reinforcements in polymer matrices to form glass fiber reinforced plastics or composites. Glass fibers have been used in the form of continuous or chopped filaments, strands, rovings, woven fabrics, nonwoven fabrics, meshes, and scrims to reinforce polymers. It is known in the art that glass fiber reinforced polymer composites possess higher mechanical properties compared to unreinforced polymer composites, provided that the reinforcement fiber surface is suitably modified by a sizing composition. Thus, better dimensional stability, tensile strength and modulus, flexural strength and modulus, impact resistance, and creep resistance may be achieved with glass fiber reinforced composites.

Chopped glass fibers are commonly used as reinforcement materials in reinforced composites. Conventionally, glass fibers are formed by attenuating streams of a molten glass material from a bushing or orifice. An aqueous sizing composition, or chemical treatment, is typically applied to the glass fibers after they are drawn from the bushing. An aqueous sizing composition commonly containing lubricants, coupling agents, and film-forming binder resins is applied to the fibers. The sizing composition provides protection to the fibers from interfilament abrasion and promotes compatibility between the glass fibers and the matrix in which the glass fibers are to be used.

The wet, sized fibers may then be split and gathered into strands at a gathering shoe and wound onto a collet into forming packages or cakes. The forming cakes are heated in an oven at a temperature from about 212° F. to about 270° F. for about 15 to about 20 hours to remove water and cure the size composition on the surface of the fibers. After the fibers are dried, they may be transported to a chopper where the fibers are chopped into chopped strand segments. Such a process is referred to as an “off-line” process because the fibers are dried and chopped after the glass fibers are formed. The chopped strand segments may be mixed with a polymeric resin and supplied to a compression- or injection-molding machine to be formed into glass fiber reinforced composites.

Although the current off-line process forms a suitable and marketable end product, the off-line process is time consuming not only in that the forming and chopping occurs in two separate steps, but also in that it requires extensive, lengthy drying times to fully cure the size composition. Thus, there exists a need in the art for a cost-effective and efficient process that completes the product fabrication in continuous steps with the glass fabrication process in a shorter period of time.

### SUMMARY OF THE INVENTION

It is an object of the present invention to provide a composition for a reinforcing fiber used to reinforce thermoset resins that includes at least one silane coupling agent and one or more polyurethane film forming agents. In addition, the composition is free of additives that are typically included in conventional sizing applications to impose desired properties or characteristics to the size composition and/or end product formed from fibers sized with the sizing composition. Suitable film formers for use in the inventive size composition include polyurethane film formers (blocked or thermoplastic), epoxy resin film formers, polyolefins, modified polyolefins, functionalized polyolefins, and saturated and unsaturated polyester resin film formers, either alone or in any combination. The polyurethane film former may be in the form of an aqueous dispersion, emulsion, and/or solution of film formers. The polyurethane dispersion(s) utilized in the sizing formulation may be a polyurethane dispersion that is based or not based on a blocked isocyanate. In preferred embodiments, the polyurethane dispersion includes a blocked isocyanate. In the inventive size composition, the isocyanate preferably de-blocks at a temperature between about 200° F. to about 400° F., and more preferably at a temperature between about 225° F. to about 350° F. Examples of silane coupling agents that may be used in the size composition may be characterized by the functional groups amino, epoxy, vinyl, methacryloxy, ureido, isocyanato, and azamido. Silane coupling agents that may be used in the size composition include aminosilanes, silane esters, vinyl silanes, methacryloxy silanes, epoxy silanes, sulfur silanes, ureido silanes, and isocyanato silanes. The inventive size composition permits reinforcement fibers sized with the inventive composition to be chopped and dried in-line to form chopped fiber bundles. Chopping the glass fibers in-line lowers the manufacturing costs for the products produced from the sized glass fibers.

It is another object of the present invention to provide a reinforcing fiber strand that is formed of a plurality of individual reinforcement fibers that are at least partially coated with a sizing composition. In particular, the reinforcing fiber strand is at least partially coated with a coating composition that consists of at least one silane coupling agent, a polyurethane film forming agent including a blocked isocyanate, and water. Examples of silane coupling agents that may be used in the sizing composition include aminosilanes, silane esters, vinyl silanes, methacryloxy silanes, epoxy silanes, sulfur silanes, ureido silanes, and isocyanato silanes. The blocking agent utilized on the polyurethane film former preferably de-blocks at a temperature that permits simultaneous or nearly simultaneous de-blocking and curing of the polyurethane film former. Preferably, the isocyanate de-blocks at a temperature between about 200° F. to about 400° F., and more preferably at a temperature between about 225° F. to about 350° F. The polyurethane film forming dispersion that includes a blocked isocyanate may be present in the sizing formulation in an amount from about 1 to about 10% by weight of the total composition and the silane coupling agent(s) may be present in the size composition in an amount from about 0.2 to about 1.0% by weight of the total composition.

It is yet another object of the present invention to provide a method of forming a reinforced composite article that includes applying a size composition to a plurality of attenuated glass fibers, gathering the glass fibers into glass fiber strands that have a predetermined number of glass fibers therein, chopping the glass fiber strands to form wet chopped glass fiber bundles, drying the wet chopped glass fiber bundles in a drying oven to form chopped glass fiber bundles, combining the chopped fiber bundles with a thermoset resin, and placing the combination of chopped fiber bundles and thermoset resin into a heated mold to effect cure of the thermoset resin and form a composite product. The wet, chopped glass fiber bundles are preferably dried in a fluidized bed oven at temperatures from about 300° F. to about 500° F. The size composition includes at least one silane coupling agent and one or more polyurethane film forming agents including a blocked isocyanate. Additionally, the size composition is free of any additives that are typically included in conventional sizing applications to impose desired properties or characteristics to the size composition. The polyurethane film forming agent may be a polyester-based polyurethane film forming agent including a blocked isocyanate. The blocked isocyanate desirably de-blocks at a temperature between about 225° F. to about 350° F. The glass fibers can be chopped and dried at a much faster rate in-line with the inventive size composition compared to conventional off-line chopping processes.

It is a further object of the present invention to provide a method of forming a reinforced composite article that includes depositing chopped glass strands at least partially coated with a sizing composition on a first polymer film, positioning a second polymer film on the chopped glass fibers to form a sandwiched material, and molding the sandwiched material into a reinforced composite article. The sizing composition consists of at least one silane coupling agent, a polyurethane film forming dispersion that includes a blocked isocyanate, and water. The method may also include applying the size composition to a plurality of attenuated glass fibers, gathering the glass fibers into glass fiber strands, chopping the glass fiber strands to form wet chopped glass fiber bundles, and drying the wet chopped glass fiber bundles at temperatures from about 300° F. to about 500° F. in a fluidized-bed oven to form the chopped glass strands. Non-limiting examples of silane coupling agents that may be used in the sizing composition include aminosilanes, silane esters, vinyl silanes, methacryloxy silanes, epoxy silanes, sulfur silanes, ureido silanes, and isocyanato silanes. The polyurethane film forming agent may be a polyester-based polyurethane film forming agent that includes a blocked isocyanate. The blocking agent utilized on the polyurethane film former preferably de-blocks at a temperature that permits simultaneous or nearly simultaneous de-blocking and curing of the polyurethane film former. Preferably, the isocyanate de-blocks at a temperature between about 200° F. to about 400° F., and more preferably at a temperature between about 225° F. to about 350° F.

It is an advantage of the present invention that chopped reinforcement strands (e.g., chopped glass strands) can be fabricated in a fraction of the time of conventional products at a fraction of the cost.

It is another advantage of the present invention that the in-line chopping and drying of the reinforcement fibers increases productivity.

It is a further advantage of the present invention that the manufacturing cost and manufacturing time of products formed by the sized, chopped fibers are reduced by chopping and drying the reinforcement fibers in-line.

It is yet another advantage of the present invention that the in-line process utilized with the inventive size formulation is less labor intensive than off-line processes.

It is a feature of the present invention that the blocking agent utilized on the polyurethane film former may de-block at a temperature that permits simultaneous or nearly simultaneous de-blocking and curing of the polyurethane film former.

It is another feature of the present invention that the blocking agent de-blocks at a temperature that permits the film forming agent to cure in a short period of time.

The foregoing and other objects, features, and advantages of the invention will appear more fully hereinafter from a consideration of the detailed description that follows.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a flow diagram illustrating steps of an exemplary process for forming glass fiber bundles according to at least one exemplary embodiment of the present invention;

FIG. 2 is a schematic illustration of a processing line for forming dried chopped strand bundles according to at least one exemplary embodiment of the present invention;

FIG. 3 is a schematic illustration of a chopped strand bundle according to an exemplary embodiment of the present invention;

FIG. 4 is a graphical illustration of the flexural strength of an injection-molded composite part formed with fibers sized with the inventive in-line size composition and injection-molded composite parts formed with the closest off-line size compositions;

FIG. 5 is a graphical illustration of the flexural modulus of an injection-molded composite part formed with fibers sized with the inventive in-line size composition and injection-molded composite parts formed with the closest off-line size compositions;

FIG. 6 is a graphical illustration of the tensile strength of an injection-molded composite part formed with fibers sized with the inventive in-line size composition and injection-molded composite parts formed with the closest off-line size compositions;

FIG. 7 is a graphical illustration of the Izod impact strength of an injection-molded composite part formed with fibers sized with the inventive in-line size composition and injection-molded composite parts formed with the closest off-line size compositions;

FIG. 8 is a graphical illustration of the flexural strength of compression molded composite part formed with fibers sized with the inventive in-line size composition and compression molded composite parts formed with the closest off-line size compositions;

FIG. 9 is a graphical illustration of the flexural modulus of compression molded composite part formed with fibers sized with the inventive in-line size composition and compression molded composite parts formed with the closest off-line size compositions;

FIG. 10 is a graphical illustration of the tensile strength of compression molded composite part formed with fibers sized with the inventive in-line size composition and compression molded composite parts formed with the closest off-line size compositions; and

FIG. 11 is a graphical illustration of the Izod impact strength of compression molded composite part formed with fibers sized with the inventive in-line size composition and compression molded composite parts formed with the closest off-line size compositions.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, and any other references, are each incorporated by reference in their entireties, including all data, tables, figures, and text presented in the cited references.

In the drawings, the thickness of the lines, layers, and regions may be exaggerated for clarity. It is to be noted that like numbers found throughout the figures denote like elements. The terms “reinforcing fiber” and “reinforcement fiber” may be used interchangeably herein. In addition, the terms “size”, “sizing”, “size composition” and “sizing composition” may be used interchangeably. Additionally, the terms “film former” and “film forming agent” may be used interchangeably. Further, the terms “composition” and “formulation” may be used interchangeably herein.

The present invention relates to a sizing composition for reinforcement fibers. The sizing composition includes at least one silane coupling agent, one or more polyurethane film forming agents, and water. In preferred embodiments, the polyurethane film forming agent(s) is a polyurethane film forming agent that includes a blocked isocyanate. The blocking agent utilized on the polyurethane film former preferably de-blocks at a temperature that permits simultaneous or nearly simultaneous de-blocking and curing of the polyurethane film former. The size composition permits reinforcement fibers sized with the inventive composition to be chopped and dried in-line to form chopped fiber bundles. Chopping the glass fibers in-line lowers the manufacturing costs for the products produced from the sized glass fibers. Additionally, in-line processes are less labor-intensive then off-line processes that require workers to physically remove the forming cake from the collet and take it to be dried. Further, because the reinforcement fibers can be chopped and dried at a much faster rate with the inventive size composition compared to conventional off-line chopping processes, productivity is increased.

The sizing composition may be used to treat a continuous reinforcing fiber. The size composition may be applied to the reinforcing fibers by any conventional method, including kiss roll, dip-draw, slide, or spray application to achieve the desired amount of the sizing composition on the fibers. Any type of glass, such as A-type glass, C-type glass, E-type glass, S-type glass, ECR-type glass fibers, boron-free fibers (e.g., Advantex® glass fibers commercially available from Owens Corning), wool glass fibers, or combinations thereof may be used as the reinforcing fiber. Preferably, the reinforcing fiber is an E-type glass or Advantex® glass. The inventive sizing composition may be applied to the fibers with a Loss on Ignition (LOI) from about 0.2 to about 1.5 on the dried fiber, preferably from about 0.4 to about 0.70, and most preferably from about 0.4 to about 0.6. As used in conjunction with this application, LOI may be defined as the percentage of organic solid matter deposited on the glass fiber surfaces.

Alternatively, the reinforcing fiber may be strands of one or more synthetic polymers such as, but not limited to, polyester, polyamide, aramid, polyaramid, polypropylene, polyethylene, and mixtures thereof. The polymer strands may be used alone as the reinforcing fiber material, or they can be used in combination with glass strands such as those described above. As a further alternative, natural fibers, mineral fibers, carbon fibers, and/or ceramic fibers may be used as the reinforcement fiber. The term “natural fiber” as used in conjunction with the present invention refers to plant fibers extracted from any part of a plant, including, but not limited to, the stem, seeds, leaves, roots, or phloem. Examples of natural fibers suitable for use as the reinforcing fiber include cotton, jute, bamboo, ramie, bagasse, hemp, coir, linen, kenaf, sisal, flax, henequen, and combinations thereof.

As discussed above, the sizing composition contains at least one silane coupling agent. Besides their role of coupling the surface of the reinforcement fibers and the plastic matrix, silanes also function to reduce the level of fuzz, or broken fiber filaments, during subsequent processing. When needed, a weak acid such as acetic acid, boric acid, metaboric acid, succinic acid, citric acid, formic acid, and/or polyacrylic acid may be added to the size composition to assist in the hydrolysis of the silane coupling agent. Examples of silane coupling agents that may be used in the size composition may be characterized by the functional groups amino, epoxy, vinyl, methacryloxy, ureido, isocyanato, and azamido. In preferred embodiments, the silane coupling agents include silanes containing one or more nitrogen atoms that have one or more functional groups such as amine (primary, secondary, tertiary, and quaternary), amino, imino, amido, imido, ureido, isocyanato, or azamido.

Non-limiting examples of suitable silane coupling agents include aminosilanes, silane esters, vinyl silanes, methacryloxy silanes, epoxy silanes, sulfur silanes, ureido silanes, and isocyanato silanes. Specific examples of silane coupling agents for use in the instant invention include γ-aminopropyltriethoxysilane (A-1100), n-phenyl-γ-aminopropyltrimethoxysilane (Y-9669), n-trimethoxy-silyl-propyl-ethylene-diamine (A-1120), methyl-trichlorosilane (A-154), γ-chloropropyl-trimethoxy-silane (A-143), vinyl-triacetoxy silane (A-188), methyltrimethoxysilane (A-1630), γ-ureidopropyltrimethoxysilane (A-1524). Other examples of suitable silane coupling agents are set forth in Table 1. All of the silane coupling agents identified above and in Table 1 are available commercially from GE Silicones. Preferably, the silane coupling agent is an aminosilane or a diaminosilane.

TABLE 1

| Silanes | Label |
|---|---|
| Silane Esters | |
| Octyltriethoxysilane | A-137 |
| Methyltriethoxysilane | A-162 |
| Methyltrimethoxysilane | A-163 |
| Vinyl Silanes | |
| Vinyltriethoxysilane | A-151 |
| Vinyltrimethoxysilane | A-171 |
| vinyl-tris-(2-methoxyethoxy) | A-172 |
| silane | |
| Methacryloxy Silanes | |
| Γ-methacryloxypropyl- | A-174 |
| trimethoxysilane | |
| Epoxy Silanes | |
| B-(3,4-epoxycyclohexyl)- | A-186 |
| ethyltrimethoxysilane | |
| Sulfur Silanes | |
| γ- | A-189 |
| mercaptopropyltrimethoxysilane | |
| Amino Silanes | |
| γ-aminopropyltriethoxysilane | A-1101 |
| | A-1102 |
| aminoalkyl silicone | A-1106 |
| γ-aminopropyltrimethoxysilane | A-1110 |
| Triaminofunctional silane | A-1130 |
| bis-(γ- | A-1170 |
| trimethoxysilylpropyl)amine | |
| Polyazamide silylated silane | A-1387 |
| Ureido Silanes | |
| γ-ureidopropyltrialkoxysilane | A-1160 |
| γ-ureidopropyltrimethoxysilane | Y-11542 |
| Isocyanato Silanes | |
| γ-isocyanatopropyltriethoxysilane | A-1310 |

The size composition may include one or more coupling agents. In addition, the coupling agent(s) may be present in the size composition in an amount from about 0.2 to about 1.0% by weight of the total composition, preferably in an amount from about 0.3 to about 0.7% by weight, and more preferably in an amount from about 0.4 to about 0.5% by weight.

The polyurethane agent(s) utilized in the sizing formulation of the present invention may be a polyurethane dispersion that either is based or is not based on a blocked isocyanate. In preferred embodiments, the polyurethane dispersion includes a blocked isocyanate. Film formers are agents that create improved adhesion between the reinforcing fibers, which results in improved strand integrity. In the size composition, the film former acts as a polymeric binding agent to provide additional protection to the reinforcing fibers and to improve processability, such as to reduce fuzz that may be generated by high speed chopping. As used herein, the term “blocked” is meant to indicate that the isocyanate groups have been reversibly reacted with a compound so that the resultant blocked isocyanate group is stable to active hydrogens at ambient temperature but reactive with active hydrogens in the film forming polymer at elevated temperatures, such as, for example, at temperatures between about 200° F. to about 400° F.

Suitable film formers for use in the present invention include polyurethane film formers (blocked or thermoplastic), epoxy resin film formers, polyolefins, modified polyolefins, functionalized polyolefins, polyvinyl acetate, polyacrylates, and saturated and unsaturated polyester resin film formers, either alone or in any combination. Specific examples of aqueous dispersions, emulsions, and solutions of film formers include, but are not limited to, polyurethane dispersions such as Neoxil 6158 (available from DSM); polyester dispersions such as Neoxil 2106 (available from DSM), Neoxil 9540 (available from DSM), and Neoxil PS 4759 (available from DSM); epoxy resin dispersions such as PE-412 (available from AOC), NX 9620 (available from DSM), Neoxil 0151 (available from DSM), Neoxil 2762 (DSM), NX 1143 (available from DSM), AD 502 (available from AOC), Epi Rez 5520 (available from Hexion), Epi Rez 3952 (available from Hexion), Witcobond W-290H (available from Chemtura), and Witcobond W-296 (available from Chemtura); and polyether dispersions. Polyurethane film formers are a preferred class of film formers for use in the size composition because they help to improve the dispersion of glass fiber bundles in the resin melt (e.g., extrusion process or injection molding process) when forming a composite article, which, in turn, causes a reduction or elimination of defects in the final article that are caused by poor dispersion of the reinforcement fibers (e.g., visual defects, processing breaks, and/or low mechanical properties). Preferred film formers for use in the size composition include polyester-based and polyether-based polyurethane dispersions.

Examples of suitable polyurethane film formers that are not based on blocked isocyanates that may be used in the sizing composition include, but are not limited to, Baybond® XP-2602 (a non-ionic polyurethane dispersion available from Bayer Corp.); Baybond® PU-401 and Baybond® PU-402 (anionic urethane polymer dispersions available from Bayer Corp.); Baybond® VP-LS-2277 (an anionic/non-ionic urethane polymer dispersion available from Bayer Corp.); Aquathane 518 (a non-ionic polyurethane dispersion available from Dainippon, Inc.); and Witcobond 290H (polyurethane dispersion available from Witco Chemical Corp.).

The isocyanate utilized in the sizing composition can be fully blocked or partially blocked so that it will not react with the active hydrogens in the melted resin until the strands of chemically treated (i.e., sized) glass fibers are heated to a temperature sufficient to unblock the blocked isocyanate and cure the film forming agent. In the inventive size composition, the isocyanate preferably de-blocks at a temperature between about 200° F. to about 400° F., more preferably at a temperature between about 225° F. to about 350° F., and most preferably at a temperature between about 230° F. to about 330° F. Groups suitable for use as the blocker or blocking portion of the blocked isocyanate are well-known in the art and include groups such as alcohols, lactams, oximes, malonic esters, alkyl acetoacetates, triazoles, phenols, amines, and benzyl t-butylamine (BBA). One or several different blocking groups may be used. The blocked polyurethane film forming agent may be present in the sizing composition in an amount from about 1.0 to about 10% by weight of the total composition, preferably in an amount from about 3 to about 8% by weight, and most preferably in an amount from about 4 to about 6% by weight.

The size composition further includes water to dissolve or disperse the active solids for application onto the glass fibers. Water may be added in an amount sufficient to dilute the aqueous sizing composition to a viscosity that is suitable for its application to glass fibers and to achieve the desired solids content on the fibers. In particular, the size composition may contain up to about 99% water.

In addition, in some exemplary embodiments, the size composition may optionally include at least one lubricant to facilitate fiber manufacturing and composite processing and fabrication. In embodiments where a lubricant is utilized, the lubricant may be present in the size composition in an amount from about 0.004 to about 0.05% by weight of the total composition. Although any suitable lubricant may be used, examples of lubricants for use in the sizing composition include, but are not limited to, water-soluble ethyleneglycol stearates (e.g., polyethyleneglycol monostearate, butoxyethyl stearate, polyethylene glycol monooleate, and butoxyethylstearate), ethyleneglycol oleates, ethoxylated fatty amines, glycerin, emulsified mineral oils, organopolysiloxane emulsions, carboxylated waxes, linear or (hyper)branched waxes or polyolefins with functional or non-functional chemical groups, functionalized or modified waxes and polyolefins, nanoclays, nanoparticles, and nanomolecules. Specific examples of lubricants suitable for use in the size composition include stearic ethanolamide, sold under the trade designation Lubesize K-12 (available from AOC); PEG 400 MO, a monooleate ester having about 400 ethylene oxide groups (available from Cognis); Emery 6760 L, a polyethyleneimine polyamide salt (available from Cognis); Lutensol ON60 (available from BASF); Radiacid (a stearic acid available from Fina); and Astor HP 3040 and Astor HP 8114 (microcrystalline waxes available from IGI International Waxes, Inc).

Although the inventive size composition is desirably free of any additives that are typically included in conventional sizing applications to impose desired properties or characteristics to the size composition and/or to the final composite product, additives such as pH adjusters, UV stabilizers, antioxidants, processing aids, lubricants, antifoaming agents, antistatic agents, thickening agents, adhesion promoters, compatibilizers, stabilizers, flame retardants, impact modifiers, pigments, dyes, colorants and/or fragrances may be added in small quantities to the sizing composition in some exemplary embodiments. The total amount of additives that may be present in the size composition may be from 0 to about 5.0% by weight of the total composition, and in some embodiments, the additives may be added in an amount from about 0.2 to about 5.0% by weight of the total composition.

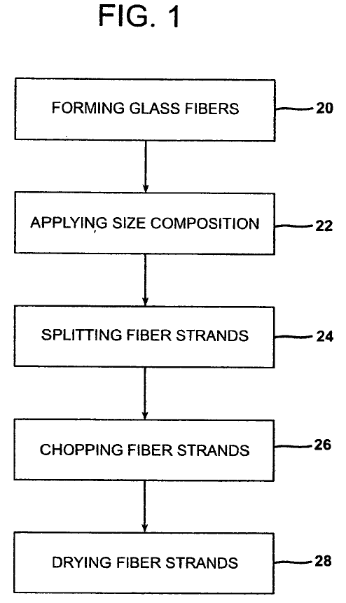

In one exemplary embodiment, described generally in FIG. 1, a process of forming chopped glass fiber bundles in accordance with one aspect of the invention is depicted. In particular, the process includes forming glass fibers (Step 20), applying the size composition to glass fibers (Step 22), splitting the fibers to obtain a desired bundle tex (Step 24), chopping the wet fiber strands to a discrete length (Step 26), and drying the wet strands (Step 28) to form chopped glass fiber bundles.

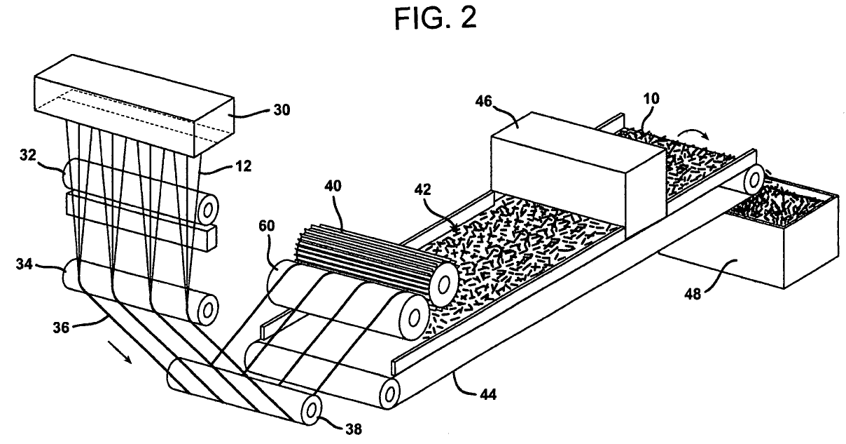

As shown in more detail in FIG. 2, glass fibers 12 may be formed by attenuating streams of a molten glass material (not shown) from a bushing or orifice 30. The size composition is preferably applied to the fibers in an amount sufficient to provide the fibers with a moisture content from about 10% to about 14%. The attenuated glass fibers 12 may have a diameter from about 9.5 microns to about 16 microns. Preferably, the fibers 12 have a diameter from about 10 microns to about 14 microns.

After the glass fibers 12 are drawn from the bushing 30, the inventive aqueous sizing composition is applied to the fibers 12. The sizing may be applied by conventional methods such as by the application roller 32 shown in FIG. 2. Once the glass fibers 12 are treated with the sizing composition, they are gathered and split into fiber strands 36 having a specific, desired number of individual glass fibers 12. The splitter shoe 34 splits the attenuated, sized glass fibers 12 into fiber strands 36. The glass fiber strands 36 may optionally be passed through a second splitter shoe (not shown) prior to chopping the fiber strands 36. The specific number of individual glass fibers 12 present in the fiber strands 36 (and therefore the number of splits of the glass fibers 12) will vary depending on the particular application for the chopped glass fiber bundles 10, and is easily determined by one of ordinary skill in the art. In the present invention, it is preferred that each reinforcing fiber strand or bundle contains from approximately 200 fibers to approximately 8,000 fibers or more.

The fiber strands 36 are then passed from the gathering shoe 38 to a chopper 40/cot 60 combination where they are chopped into wet chopped glass fiber bundles 42. The strands 36 may be chopped to have a length from about 0.125 to about 1.0 inch, preferably from about 0.125 to about 0.5 inches, and most preferably from about 0.125 to about 0.25 inches. The wet, chopped glass fiber bundles 42 may fall onto a conveyor 44 (such as a foraminous conveyor) for conveyance to a drying oven 46.

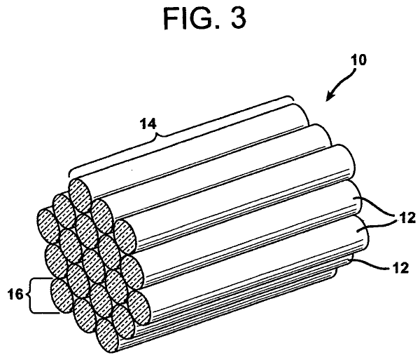

The bundles of wet, sized chopped fibers 42 are then dried to consolidate or solidify the sizing composition on the glass fibers 12. Preferably, the wet fiber bundles 42 are dried in an oven 46 such as a fluidized-bed oven (i.e., a Cratec® oven (available from Owens Corning)), a rotating thermal tray oven, or a dielectric oven to form the dried, chopped glass fiber bundles 10. An example of a chopped glass fiber bundle 10 according to the present invention is depicted generally in FIG. 3. As shown in FIG. 3, the chopped glass fiber bundle 10 is formed of a plurality of individual glass fibers 12 having a diameter 16 and a length 14. The individual glass fibers 12 are positioned in a substantially parallel orientation to each other in a tight knit or “bundled” formation. As used herein, the phrase “substantially parallel” is meant to denote that the individual glass fibers 12 are parallel or nearly parallel to each other.

To reduce the drying time to a level that is acceptable for commercial mass production, it is preferred that the fibers are dried at elevated temperatures up to approximately 500° F. in a fluidized-bed oven (e.g., Cratec® drying oven), and more preferably at temperatures from about 300° F. to about 500° F. In a fluidized-bed oven, the wet chopped glass fibers are dried and the sizing composition on the fibers is solidified using a hot air flow having a controlled temperature. The dried fibers may then passed over screens (not shown) to remove longs, fuzz balls, and other undesirable matter before the chopped glass fibers are collected. In addition, the high oven temperatures that are typically found in Cratec® ovens allow the size to quickly cure to a very high level (i.e., degree) of cure, which reduces occurrences of premature filamentization. In exemplary embodiments, greater than (or equal to) about 99% of the free water (i.e., water that is external to the chopped fiber bundles) is removed. It is desirable, however, that substantially all of the water is removed by the drying oven 46. The phrase “substantially all of the water,” as it is used herein, is meant to denote that all or nearly all of the free water from the fiber bundles is removed.

The dried, sized, chopped reinforcement fiber bundles may be used to reinforce thermoset polymers. Examples of suitable thermoset polymers include polyester, vinyl esters, phenolic resins, epoxy resins, alkyls, and diallylphthalate (DAP). For example, the sized reinforcement fibers may be used in a bulk molding compound (BMC). In the present invention, the bulk molding compound may be a combination of a thermoset resin, chopped reinforcement strands (e.g., glass strands) sized with the inventive size composition, fillers, catalysts, and additives. In at least one exemplary embodiment, a bulk molding compound containing sized glass strands is injected into a heated mold by an injection molding machine to effect crosslinking and cure of the thermoset resin. It is desirable that the glass fiber bundles have bundle integrity when the metal die closes and is heated so that the bulk molding compound can flow and fill the die to form the desired composite part. However, if the glass fiber bundles disassociate into single fibers within the die before the flow is complete, the individual glass fibers form clumps and incompletely fill the die, thereby resulting in a defective part. After the bulk molding compound has flowed and the die has been filled, it is desirable that the glass fiber bundles filamentize at that time to reduce the occurrence of, or even prevent, “telegraphing” or “fiber print”, which is the outline of the glass fiber bundles at the part surface. BMC injection molding is advantageous in that it has a fast cycle time and can mold numerous parts with each injection. Thus, more final parts can be formed with a BMC material and manufacturing times can be increased.

Another example of utilizing the sized glass fibers is in compression molding a sheet molding compound (SMC) or a bulk molding compound (BMC). Typically, SMC processes utilize longer chopped strands than BMC molding processes. For example, about 0.125 inch to about 1 inch long chopped strands may be used in BMC processes whereas chopped strands in SMC processes may have a length from 1 to about 2 inches. In forming a sheet molding compound, the chopped glass strands may be placed onto a layer of a thermosetting polymer film, such as an unsaturated polyester resin or vinyl ester resin, positioned on a first carrier sheet that has a non-adhering surface. A second, non-adhering carrier sheet containing a second layer of a thermosetting polymer film may be positioned on the chopped glass strands in an orientation such that the second polymer film contacts the chopped glass strands and forms a sandwiched material of polymer film/sized, chopped glass strands/polymer film. The first and second thermosetting polymer film layers may contain a mixture of resins and additives such as fillers, pigments, UV stabilizers, catalysts, initiators, inhibitors, mold release agents, and/or thickeners. In addition, the first and second polymer films may be the same or they may be different from each other. This sandwiched material may then be kneaded with rollers such as compaction rollers to substantially uniformly distribute the polymer resin matrix and chopped glass strands throughout the resultant SMC material. As used herein, the term “to substantially uniformly distribute” means to uniformly distribute or to nearly uniformly distribute. The SMC material may then be stored for about 2 to about 3 days to permit the resin to thicken and mature to a target viscosity.

A matured SMC material (i.e., an SMC material that has reached the target viscosity) or a bulk molding compound containing sized glass fiber bundles may be molded in a compression molding process to form a composite product. The matured SMC material or a bulk molding compound material may be placed in one half of a matched metal mold having the desired shape of the final product. In compression molding sheet molding compounds, the first and second carrier sheets are typically removed from the matured SMC material and the matured SMC material may be cut into pieces having a pre-determined size (charge) which are placed into the mold. The mold is closed and heated to an elevated temperature and raised to a high pressure. This combination of high heat and high pressure causes the SMC or BMC material to flow and fill out the mold. The matrix resin then crosslinks or cures to form the final thermoset molded composite part.

The SMC material may be used to form a variety of composite products in numerous applications, such as in automotive applications including the formation of door panels, trim panels, exterior body panels, load floors, bumpers, front ends, underbody shields, running boards, sunshades, instrument panel structures, and door inners. In addition, the SMC material may be used to form basketball backboards, tubs and shower stalls, sinks, parts for agricultural equipment, cabinets, storage boxes, and refrigerated box cars. The bulk molding compound material may be used to form items similar to those listed above with respect to the SMC material, as well as items such as appliance cabinets, computer boxes, furniture, and architectural parts such as columns.

Having generally described this invention, a further understanding can be obtained by reference to certain specific examples illustrated below which are provided for purposes of illustration only and are not intended to be all inclusive or limiting unless otherwise specified.

### EXAMPLES

### Example 1

### Injection Molded Composite Part with Inventive Size Composition

The sizing formulation set forth in Table 2 was prepared in a bucket as described generally below. To prepare the size composition, approximately 90% of the water and the silane coupling agent were added to a bucket to form a mixture. The mixture was then agitated for a period of time to permit the silane to hydrolyze. After the hydrolyzation of the silane, the film former was added to the mixture with agitation to form the size composition. The size composition was then diluted with the remaining water to achieve the target mix solids of approximately 6.0% mix solids.

TABLE 2
Inventive Size Composition

| Component of | % by Weight of | |
|---|---|---|
| Size | Total | |
| Composition | Composition | % Solids |
| A-1100^{(a)} | 0.4 | 58.0 |
| PUD^{(b)} | 7.4 | 60.0 |

^{(a)}γ-aminopropyltrimethoxysilane (General Electric)
^{(b)}isocyanate-blocked polyurethane film forming dispersion (Chemtura)

The size composition was applied to E-glass in a conventional manner (such as a roll-type applicator as described above). The E-glass was attenuated to 14 μm glass filaments. The glass fiber bundles were then chopped with a mechanical cot/cutter combination to a length of approximately 6 mm and gathered into a bucket. The chopped glass fibers contained approximately 13% forming moisture. This moisture in chopped glass fiber bundles was removed in a fluidized-bed oven (i.e., Cratec® drying oven) at a temperature of 450° F. to form dried chopped glass fiber bundles.

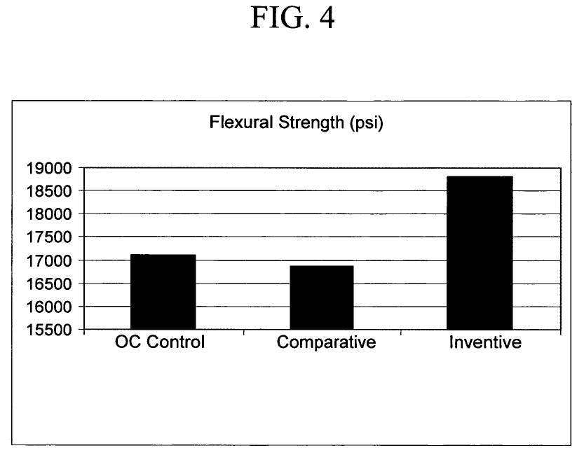

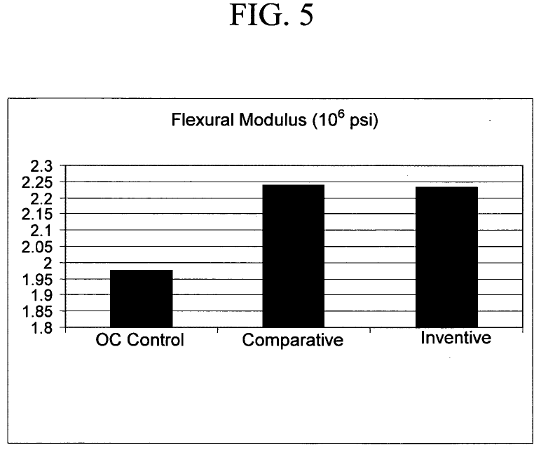

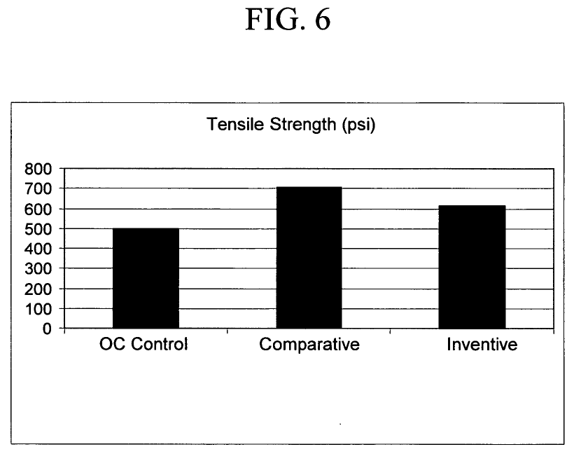

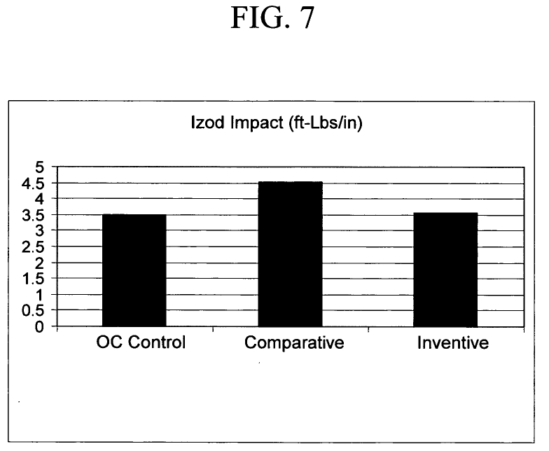

The dried, chopped fiber bundles were then combined with a polyester-based resin and injection-molded into composite parts for testing. In particular, the chopped fiber bundles and the polyester-based resin was injected into a heated mold by an injection molding machine to effect crosslinking and cure of the thermoset resin. The composite part formed from the sized glass fibers was compared to the closest off-line size composition of a competitor produced by injection-molding. A standard Owens Corning off-line size composition was also used to form an injection-molded composite part for comparative testing. In particular, the products were tested for flexural strength, flexural modulus, tensile strength, and Izod impact strength. The results are depicted graphically in FIGS. 4-7 and the data generated is set forth in Table 3.

TABLE 3

| | Control | Comparative | Inventive |
|---|---|---|---|
| | Off-Line | Off-Line | In-Line |
| | Sizing | Sizing | Sizing |
| | Composition | Composition | Composition |
| Specific Gravity (g/cm³) | 2.00 | 2.02 | 2.01 |
| Linear Shrinkage (in/in) | 0.0002 | 0.0002 | 0.0002 |
| Cure Time (seconds) | 22 | 23 | 21 |
| Flexural Strength (psi) | 17111 | 16862 | 18799 |
| Flexural Modulus | 1.977 | 2.238 | 2.234 |
| (10⁶ psi) | | | |
| Tensile Strength (psi) | 500.39 | 704.5 | 613.11 |
| Izod Impact (ft-Lbs/in) | 3.495 | 4.533 | 3.552 |

As shown in Table 3 and in FIGS. 4-7, the properties of the composite product formed from the inventive sizing composition and produced in-line are similar, if not greater than, the properties of the comparative examples produced utilizing an off-line process. For example, the flexural strength of the composite product produced with the inventive sizing composition was greater then either of the off-line control examples. The flexural modulus, tensile strength, and Izod impact strength of the product formed with the inventive sizing in-line are virtually identical to the comparative off-line examples. Thus, it can be concluded that composite products produced using the inventive sizing composition are commercially acceptable, are comparable to off-line produced products, and are provided at a lower cost due to the ability to utilize an in-line process with the inventive sizing composition.

### Example 2

### Compression Molded Composite Part with Inventive Size Composition

The sizing formulation set forth in Table 4 was prepared in a bucket as described generally below. To prepare the size composition, approximately 90% of the water and the silane coupling agent were added to a bucket to form a mixture. The mixture was then agitated for a period of time to permit the silane to hydrolyze. After the hydrolyzation of the silane, the film former was added to the mixture with agitation to form the size composition. The size composition was then diluted with the remaining water to achieve the target mix solids of approximately 6.0% mix solids.

TABLE 4
Inventive Size Composition

| Component of | % by Weight of | |
|---|---|---|
| Size | Total | |
| Composition | Composition | % Solids |
| A-1100^{(a)} | 0.4 | 58.0 |
| PUD^{(b)} | 7.4 | 60.0 |

^{(a)}γ-aminopropyltrimethoxysilane (General Electric)
^{(b)}isocyanate-blocked polyurethane film forming dispersion (Chemtura)

The size composition was applied to E-glass in a conventional manner (such as a roll-type applicator as described above). The E-glass was attenuated to 14 μm glass filaments. The glass fiber bundles were then chopped with a mechanical cot/cutter combination to a length of approximately 6 mm and gathered into a bucket. The chopped glass fibers contained approximately 13% forming moisture. This moisture in chopped glass fiber bundles was removed in a fluidized-bed oven (i.e., Cratec® drying oven) at a temperature of 450° F. to form dried chopped glass fiber bundles.

The dried, chopped fiber bundles were then combined with a polyester-based resin to form a compound material and compression molded into composite parts for testing. In particular, the chopped fiber bundles sized with the inventive sizing formulation and the polyester-based resin were placed in one half of a matched metal mold having the desired shape of the final product. The mold was then closed and heated to an elevated temperature and raised to a high pressure. This combination of high heat and high pressure caused the compound material to flow and fill the mold. The polyester-based resin was cured by the high heat which formed the final thermoset molded composite part.

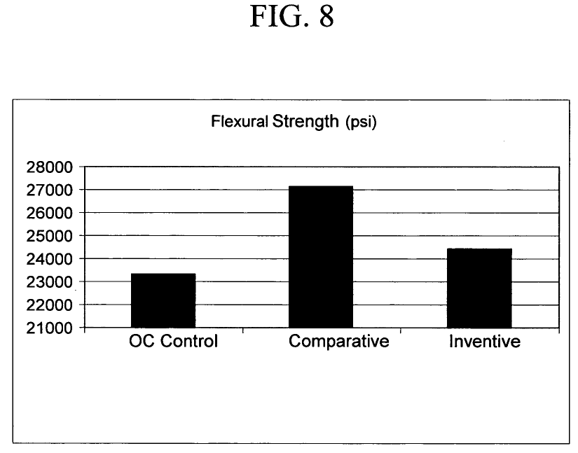

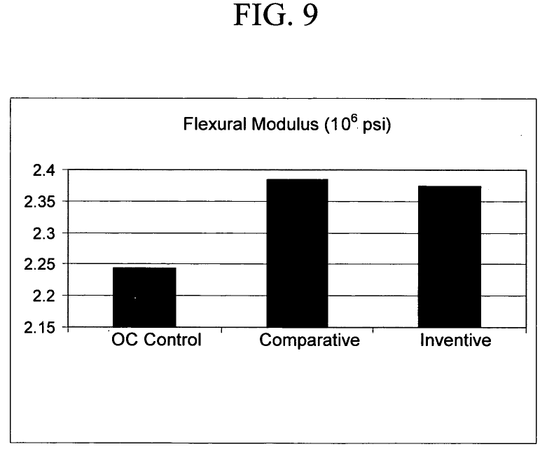

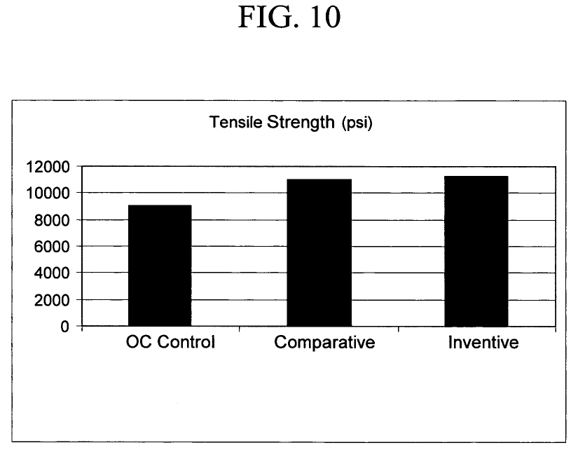

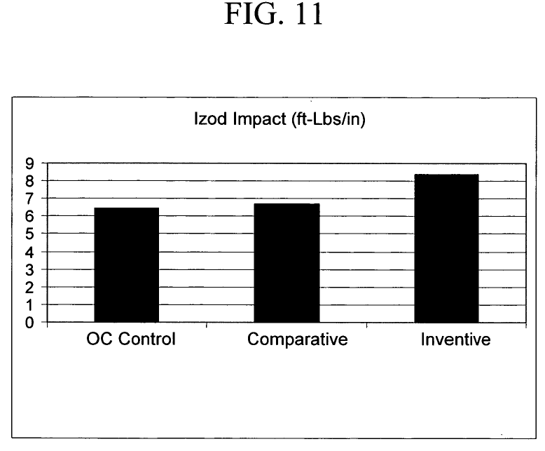

The composite part formed from the sized glass fibers was compared to the closest off-line competitor size composition produced by compression molding. A standard Owens Corning off-line size composition was also used to form a compression molded composite part for comparative testing. In particular, the products were tested for flexural strength, flexural modulus, tensile strength, and Izod impact strength. The results are depicted graphically in FIGS. 8-11 and the data generated is set forth in Table 5.

TABLE 5

| | Control | Comparative | Inventive |
|---|---|---|---|
| | Off-Line | Off-Line | In-Line |
| | Sizing | Sizing | Sizing |
| | Composition | Composition | Composition |
| Specific Gravity (g/cm³) | 2.00 | 2.02 | 2.01 |
| Linear Shrinkage (in/in) | 0.0002 | 0.0002 | 0.0002 |
| Cure Time (seconds) | 22 | 23 | 21 |
| Flexural Strength (psi) | 23327 | 27158 | 24444 |
| Flexural Modulus(10⁶ psi) | 2.243 | 2.384 | 2.374 |
| Tensile Strength (psi) | 9064.6 | 11007.4 | 11251.1 |
| Izod Impact (ft-Lbs/in) | 6.435 | 6.734 | 8.408 |

As shown in Table 5 and in FIGS. 8-11, the properties of the composite product produced in-line with the inventive sizing composition are similar to, if not greater than, the properties of the comparative examples produced utilizing an off-line process. For example, the flexural modulus, tensile strength, and Izod impact strength of the composite product formed with the inventive sizing in-line was greater then or virtually identical to the off-line control examples. In addition, the flexural strength was demonstrated to be greater than the control off-line sizing composition. Thus, composite products produced formed with fibers sized with the inventive sizing composition are commercially acceptable. In addition, the composite products formed utilizing the inventive size composition are comparable to off-line produced products and are provided at a lower cost due to the ability to utilize an in-line process with the inventive sizing composition.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A composition for a reinforcing fiber used to reinforce thermoset resins comprising:
at least one silane coupling agent; and
one or more film forming agents,
wherein said composition is free of any additives that are typically included in conventional sizing applications to impose desired properties or characteristics to the size composition.

2. The composition of claim 1, wherein said one or more film forming agents are selected from blocked polyurethane film formers, thermoplastic polyurethane film formers, epoxy resin film formers, polyolefins, modified polyolefins, functionalized polyolefins, polyvinyl acetate, polyacrylates, saturated polyester resin film formers, unsaturated polyester resin film formers, polyether film formers and combinations thereof.

3. The composition of claim 2, wherein said one or more film forming agents is at least one polyurethane film forming agent including a blocked isocyanate.

4. The composition of claim 3, wherein said polyurethane film forming agent including a blocked isocyanate de-blocks at a temperature that permits simultaneous or nearly simultaneous de-blocking and curing of said polyurethane film former.

5. The composition of claim 3, wherein said polyurethane film forming agent including a blocked isocyanate is selected from a polyester-based polyurethane film forming agent including a blocked isocyanate and a polyether-based polyurethane film forming agent including a blocked isocyanate.

6. The composition of claim 3, wherein said blocked isocyanate de-blocks at a temperature between about 225° F. to about 350° F.

7. The composition of claim 3, wherein said at least one silane coupling agent is selected from aminosilanes, silane esters, vinyl silanes, methacryloxy silanes, epoxy silanes, sulfur silanes, ureido silanes, isocyanato silanes and combinations thereof.

8. The composition of claim 3, wherein said at least one polyurethane film forming agent including a blocked isocyanate is present in said composition in an amount from about 1.0 to about 10% by weight of the total composition and said at least one silane coupling agent is present in said composition in an amount from about 0.2 to about 1.0% by weight of the total composition.

9. A reinforcing fiber strand comprising:
a plurality of individual reinforcing fibers at least partially coated with a sizing composition, said sizing composition consisting of at least one silane coupling agent and a polyurethane film forming agent including a blocked isocyanate.

10. The reinforcing fiber strand of claim 9, wherein said polyurethane film forming agent including a blocked isocyanate is selected from a polyester-based polyurethane film forming agent including a blocked isocyanate and a polyether-based polyurethane film forming agent including a blocked isocyanate.

11. The reinforcing fiber strand of claim 9, wherein said at least one silane coupling agent is selected from aminosilanes, silane esters, vinyl silanes, methacryloxy silanes, epoxy silanes, sulfur silanes, ureido silanes, isocyanato silanes and combinations thereof.

12. The reinforcing fiber strand of claim 9, wherein said blocked isocyanate de-blocks at a temperature between about 225° F. to about 350° F.

13. The reinforcing fiber strand of claim 12, wherein said blocked isocyanate de-blocks at a temperature between about 230° F. to about 330° F.

14. The reinforcing fiber strand of claim 9, wherein said polyurethane film forming agent including a blocked isocyanate de-blocks at a temperature that permits simultaneous or nearly simultaneous de-blocking and curing of said polyurethane film former.

15. The reinforcing fiber strand of claim 9, wherein said polyurethane film forming agent including a blocked isocyanate is present in said composition in an amount from about 1.0 to about 10% by weight of the total composition and said at least one silane coupling agent is present in said composition in an amount from about 0.2 to about 1.0% by weight of the total composition.

16. A method of forming a reinforced composite article comprising:
applying a size composition to a plurality of attenuated glass fibers, said size composition including:
at least one silane coupling agent; and
one or more polyurethane film forming agents including a blocked isocyanate,
wherein said size composition is free of any additives that are typically included in conventional sizing applications to impose desired properties or characteristics to the size composition;
gathering said plurality of glass fibers into glass fiber strands having a predetermined number of glass fibers therein;
chopping said glass fiber strands to form wet chopped glass fiber bundles, said wet chopped glass fiber bundles having a discrete length;
drying said wet chopped glass fiber bundles in a drying oven selected from a dielectric oven, a fluidized bed oven and a rotating thermal tray oven to form chopped glass fiber bundles;
combining said chopped fiber bundles with a thermoset resin to form a combination of chopped fiber bundles and thermoset resin; and
placing said combination of chopped fiber bundles and thermoset resin into a heated mold to effect cure of said thermoset resin and form a composite product.

17. The method of claim 164, wherein said drying step comprises:
drying said wet chopped glass fiber bundles at temperatures from about 300° F. to about 500° F. in a fluidized-bed oven.

18. The method of claim 17, wherein said placing step comprises:
injecting said combination into heated mold by an injection molding machine.

19. The method of claim 16, wherein said one or more polyurethane film forming agents including a blocked isocyanate de-blocks at a temperature that permits simultaneous or nearly simultaneous de-blocking and curing of said polyurethane film former.

20. The method of claim 16, wherein said blocked isocyanate de-blocks at a temperature between about 225° F. to about 350° F.

21. The method of claim 16, wherein said polyurethane film forming agent including a blocked isocyanate is selected from a polyester-based polyurethane film forming agent including a blocked isocyanate and a polyether-based polyurethane film forming agent including a blocked isocyanate.

22. The method of claim 16, wherein said at least one silane coupling agent is selected from aminosilanes, silane esters, vinyl silanes, methacryloxy silanes, epoxy silanes, sulfur silanes, ureido silanes, isocyanato silanes and combinations thereof.

23. A method of forming a reinforced composite article comprising:
depositing chopped glass strands at least partially coated with a sizing composition on a first polymer film, said sizing composition consisting of:
at least one silane coupling agent, and
a polyurethane film forming agent including a blocked isocyanate;
positioning a second polymer film on said chopped glass fibers to form a sandwiched material; and
molding said sandwiched material into a reinforced composite article.

24. The method of claim 23, further comprising:
applying said size composition to a plurality of attenuated glass fibers;
gathering said plurality of glass fibers into glass fiber strands;
chopping said glass fiber strands to form wet chopped glass fiber bundles, said wet chopped glass fiber bundles having a discrete length; and
drying said wet chopped glass fiber bundles in a drying oven selected from a dielectric oven, a fluidized bed oven and a rotating thermal tray oven to form said chopped glass strands.

25. The method of claim 24, wherein said drying step comprises:
drying said wet chopped glass fiber bundles at temperatures from about 300° F. to about 500° F. in a fluidized-bed oven.

26. The method of claim 24, further comprising:
kneading said sandwiched material to substantially uniformly distribute said glass fibers and said first and second polymer film.

27. The method of claim 24, wherein said polyurethane film forming agent including a blocked isocyanate de-blocks at a temperature that permits simultaneous or nearly simultaneous de-blocking and curing of said polyurethane film former.

28. The method of claim 23, wherein said polyurethane film forming agent including a blocked isocyanate is selected from a polyester-based polyurethane film forming agent including a blocked isocyanate and a polyether-based polyurethane film forming agent including a blocked isocyanate.

29. The method of claim 23, wherein said at least one silane coupling agent is selected from aminosilanes, silane esters, vinyl silanes, methacryloxy silanes, epoxy silanes, sulfur silanes, ureido silanes, isocyanato silanes and combinations thereof.
